(19) United States
(12) Patent Application Publication
(10) Pub. No.: US 2013/0120919 A1
(43) Pub. Date: May 16, 2013

(54) Media Control Device

(71) Applicant: Kyle Erickson, Big Piney, WY (US)

(72) Inventor: Kyle Erickson, Big Piney, WY (US)

(21) Appl. No.: 13/294,416

(22) Filed: Nov. 11, 2011

(51) Int. Cl. G06F 1/16

(52) U.S. Cl. 361/679.03; 361/679.4

(57) ABSTRACT

A media control device including a housing having an internal surface; a controller piece removably connected to the housing and substantially corresponding to the internal surface of the housing; and a connection band coupled to the housing. The controller piece includes a main processor and one or more buttons in communication with the main processor. The controller piece can be encased in a sealed plastic casing. The housing can be substantially made of aluminum. In one embodiment, the connection band is a wristband. The controller piece can include one or more snaps that correspond to one or more slots on the housing and whereby the controller piece is removably fastened to the housing. The controller piece can be coupled with a remote control device.

### BACKGROUND

In today's world, media devices of countless sizes, shapes and varieties can be found in virtually every corner of the industrialized world. Smartphones, mp3 players, tablets, etc. give users constant and immediate access to large volumes of information and entertainment which are often listened to or watched while on the move. Such devices are commonly carried in purses, backpacks, briefcases, armbands, fanny packs and numerous other conveying mechanisms. These means of conveying often make access to the devices difficult—which can be problematic of one wishes to change or stop programming or even adjust volume or other settings on the device.

The incorporation of Bluetooth® technology (Bluetooth is a registered trademark of Bluetooth SIG, Inc. located in Kirkland, Wash.) allows present media devices to communicate wirelessly with accessories. For example, Bluetooth® enabled wireless headsets have been widely used as an effective hands-free way of making and receiving telephone calls. However, such devices are not well-suited to adjust programming or settings on the devices themselves.

The foregoing limitations in the current state of the art, as well as others as discussed below, are solved by the present invention in its various embodiments.

### SUMMARY

The invention in its various embodiments includes the following features. It is a media control device having a housing and a controller piece. In certain embodiments, the controller piece corresponds to the internal surface of the housing. The controller piece can be removably connected to the housing. The controller piece includes a main processor and one or more media control buttons in communication with the main processor. A connection band can be coupled to the housing—which, in one embodiment, is a wristband. The controller piece can be encased in a sealed plastic casing affording impact and water resistance. The housing is, in certain embodiments, substantially made of aluminum.

In one embodiment, the controller piece includes one or more snaps that correspond to one or more slots on the housing and whereby the controller piece is removably fastened to the housing. The controller piece is, in certain embodiments, further capable of being coupled with a remote control device. In one embodiment, the main processor is coupled to one or more Bluetooth® transceivers. The Bluetooth® transceiver can be IOS or Android compatible.

### BRIEF DESCRIPTION OF THE DRAWINGS

FIG. 1 shows a front elevational view of a media control device according to one embodiment of the present invention.

FIG. 2 shows a partially disassembled media control device according to one embodiment of the present invention.

FIG. 3 shows a remote control with an attached media control device component according to one embodiment of the present invention.

FIG. 4 shows a top view of a media control device according to one embodiment of the present invention.

FIG. 5 shows a schematic depiction of a media control device according to one embodiment of the present invention.

### DETAILED DESCRIPTION OF THE ILLUSTRATED INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

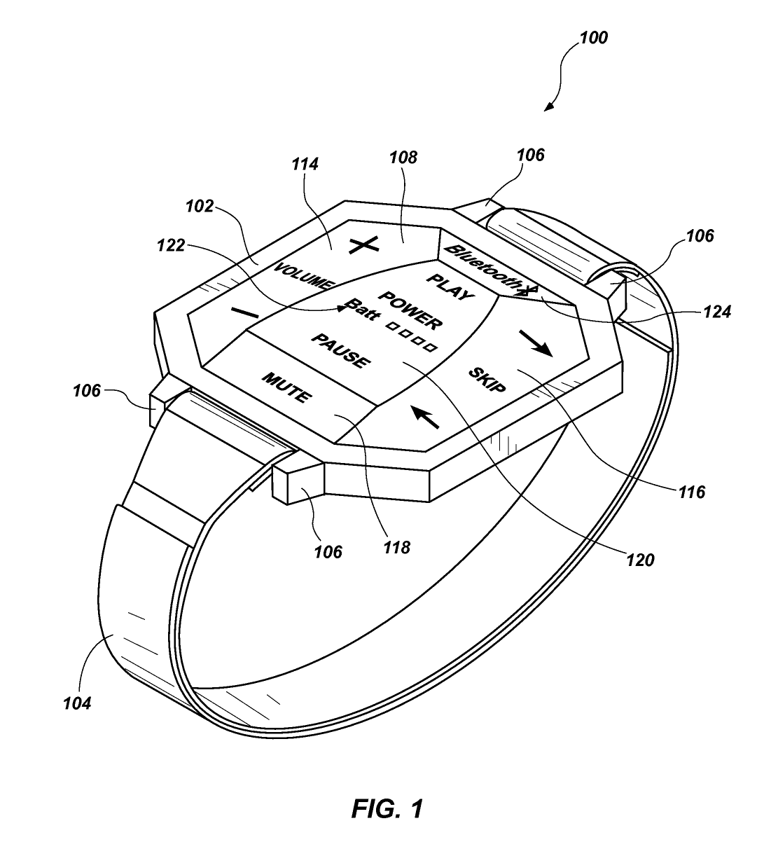

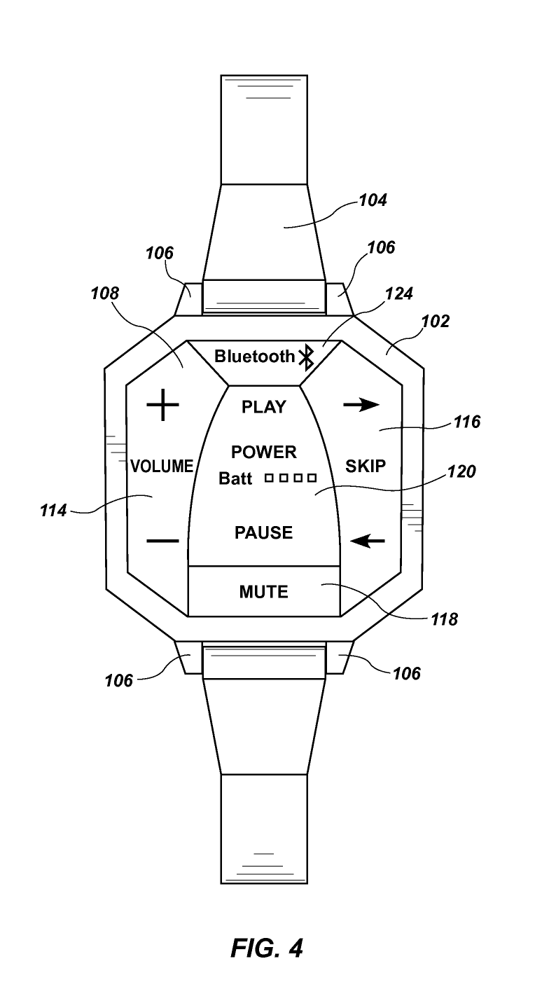

Referring now to FIGS. 1-4, a media control device 100 is shown according to one embodiment of the present invention. The media control device 100 includes a housing 102. In one embodiment, the housing is made of cast aluminum which is light weight and also, among other advantages, provides durability, scratch resistance and relatively good shock absorption. The housing 102 could also be made of other materials including, but not limited to, rubber, plastic or combinations thereof.

The device 100 can include a connection band 104. In this embodiment, the connection band 104 is a wristband attached at horns 106 with a pin or rod (not shown). In other embodiments, the connection band 104 could be an armband or could be adapted to attach to steering mechanisms such as bicycle handle bars, etc. In this embodiment, the horns 106 are integrated into the housing as a single molded piece, but it is noted that they could also be separately fastened to the housing 102. It is also noted that the connection band 104 could be attached to the housing 102 with other mechanisms that would be apparent to one skilled in the art. The connection band 104 can be made of a variety of materials including, but not limited to, leather, plastic, nylon, precious and non-precious metals and combinations thereof.

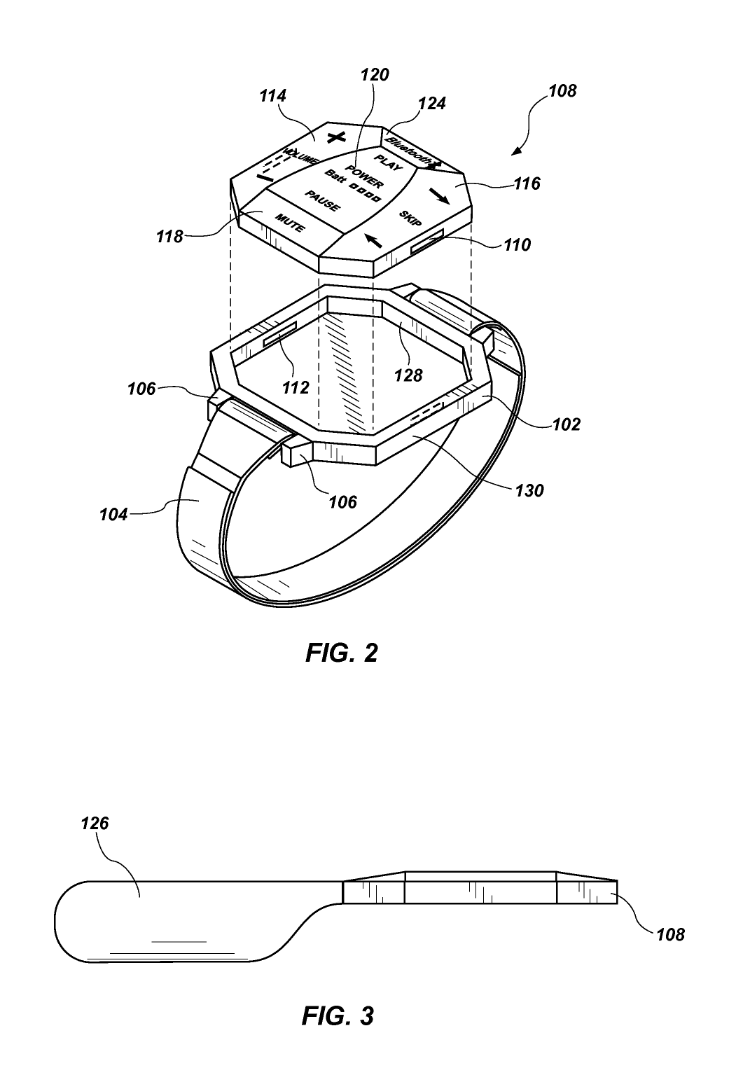

The media control device 100 can include a removable controller piece 108. In this embodiment, the controller piece 108 is substantially octagonal and corresponds to the interior and external surfaces 128, 130 (FIG. 2) of housing 102. However, it is noted that in some embodiments, the controller piece 108 and the housing 102 could be numerous other shapes including, but not limited to, substantially square; substantially rectangular; substantially circular; etc. It is also noted that in some embodiments, the controller piece 108 and corresponding internal surface 128 of housing 102 could be a different shape than the external surface 130 of the housing 102.

As best seen in FIG. 2, in one embodiment, the controller piece 108 is removably fastened to housing 102 with snaps 110 that correspond with slots 112 on the housing 102. However, it is noted that other mechanisms could be utilized to fasten the controller piece 108 to the housing 102 including, but not limited to detents, spring clips, snaps, stakes and combinations thereof. It is also noted that in one embodiment, the snaps could be on the housing and the slots on the controller piece 108.

By including the wristband 104 feature, the media control device 100 can be worn like a regular wristwatch. This allows the user to very easily control the programming or settings of a media device while engaged in activities such as running, biking, etc. It also allows the media device to be used and easily controlled when being carried in a backpack, purse, or other conveying means that would otherwise make access to the device difficult.

The controller piece 108 includes control mechanisms—which in this case are conductive rubber keypad switches available from Sigma 6 Electronics (San Diego, Calif.). Other control mechanisms that could be utilized with the present invention include, but are not limited to tactile switches available from DigiKey Corporation (Thief River Falls, Minn.). In the present embodiment, the controller piece 108 includes a volume button 114; a skip button 116; a mute button 118; a play/pause/power button 120; a battery life indicator 122; and a Bluetooth® connect/indicator button 124.

As seen in FIG. 3, once the controller piece 108 is removed, it can be incorporated into other remote control devices 126—e.g. home theater remotes, car stereo remotes, television remotes, DVD remotes, etc. In one embodiment, the remote 126 includes slots similar to those shown in FIG. 2 that correspond to the snaps 110 in the controller piece 108. Other mechanisms could be used to secure the controller 108 to the remote 126 including, but not limited to bottom fasteners.

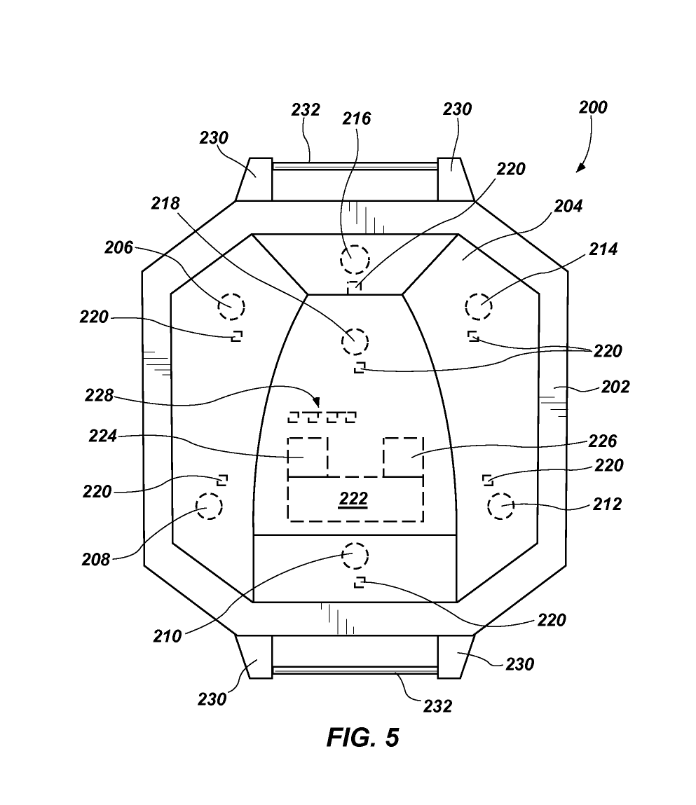

Referring now to FIG. 5, a media control device 200 is shown, according to one embodiment of the present invention, with the controller piece 204 shown schematically. The device 200 includes a housing 202. The housing 202 includes horns 230 and pins 232 used to fasten the connection band (not shown).

The controller 204 has a volume up button 206; a volume down button 208; a mute sound button 210; a skip back button 212; a skip forward button 214; a Bluetooth® connect button 216; a play/pause/power button 218. The controller 204 could also incorporate other buttons including, but not limited to scan forward and scan reverse buttons. It is noted that the utilization of Bluetooth® technology makes such media controls possible. Other buttons that could be featured on the controller include, but are not limited to macro record and special teachable functions. In this embodiment, the foregoing buttons are soft rubber buttons. In this embodiment, the controller 204 casing is a sealed plastic case. The sealed plastic case is advantageous because it is both impact and water resistant. However, the controller 204 casing could be made of other materials including, but not limited to, epoxy.

The controller 204 can also include one or more backlights 220 which, in the present embodiment, are LED lights substantially adjacent to the various buttons. It is noted that in some embodiments, it may be desirable for all of the buttons to have dedicated backlights; in other situations fewer lights may be necessary. Battery life LEDs 228 can also be included.

Controller 204 includes a main processor 222. In this embodiment, the main processor includes Bluetooth® transceiver 224, 226. In one embodiment, the Bluetooth® transceivers 224, 226 are 2.4 GHz radio transceivers available from Panasonic Corporation of North America (Secaucus, N.J.) designed around a 1325 type RF module—also available from Panasonic. The main processor 222 in one embodiment is a Cortex ARM type Stellaris LM3Sxx 32 bit microcontroller available from Texas Instruments (Dallas, Tex.).

In one embodiment, the controller 204 is powered by a rechargeable Li polymer cell. Other possible energy sources suitable for use with the present invention include, but are not limited to Li ion cells. A mini USB connector can be included for recharging the Li polymer battery under control of the microprocessor. This USB connector can be attached to any standard USB port.

It is understood that the above-described arrangements are only illustrative of the application of the basic principles of the present invention. Numerous modifications and alternative arrangements may be devised by those skilled in the art without departing from the spirit and scope of the present invention. The appended claims are intended to cover such modifications and arrangements.

What is claimed is:

1) A media control device comprising:
a) a housing having an internal surface;
b) a controller piece removably connected to the housing and substantially corresponding to the internal surface of the housing; and wherein the controller piece includes a main processor and one or more media control buttons in communication with the main processor; and
c) a connection band coupled to the housing.

2) The media control device of claim 1 wherein the controller piece is encased in a sealed plastic casing.

3) The media control device of claim 1, wherein the housing is substantially made of aluminum.

4) The media control device of claim 1, wherein the connection band is a wristband.

5) The media control device of claim 1, wherein the controller piece includes one or more snaps that correspond to one or more slots on the housing and whereby the controller piece is removably fastened to the housing.

6) The media control device of claim 1, wherein the controller piece is capable of being coupled with a remote control device.

7) The media control device of claim 1, wherein the one or more buttons are selected from the group consisting of volume buttons; sound muting buttons; skip buttons; rewind buttons; fast forward buttons; Bluetooth® connection buttons; play buttons; pause buttons; and power buttons.

8) The media control device of claim 1, wherein the main processor is a Cortex ARM type Stellaris LM3Sxx 32 bit microcontroller.

9) The media control device of claim 1, wherein the main processor is coupled to one or more Bluetooth® chip antennae.

10) The media control device of claim 9, wherein the Bluetooth® chip antenna is IOS compatible.

11) The media control device of claim 9, wherein the Bluetooth® chip antenna is Android compatible.
